(19) United States
(12) Patent Application Publication
(10) Pub. No.: US 2004/0193918 A1
(43) Pub. Date: Sep. 30, 2004

(54) Apparatus and method for network vulnerability detection and compliance assessment

(76) Inventors: Kenneth Green, Elkridge, MD (US); Joseph Patanella, Annapolis, MD (US); Erik Schetina, New York, NY (US); Brian Prather, Pasadena, MD (US)

Correspondence Address: SONG K. JUNG, McKenna Long & Aldridge LLP, 1900 K Street, NW, Washington, DC, 20006, US

(21) Appl. No.: 10/401,040

(22) Filed: Mar. 28, 2003

(51) Int. Cl. G06F 12/14

(52) U.S. Cl. 713/201

(57) ABSTRACT

The present invention relates generally to an apparatus and method for detecting vulnerabilities in networks. In particular, the present invention may relate to an apparatus and method for detecting network security flaws in a computer network. The types of computer networks which the present invention may aid in protecting include both local area and other private networks, and networks connected to the internet or a similar wide area public network.

### FIELD OF INVENTION

The present invention relates generally to an apparatus and method for assessing specific attributes of computer networks. In particular, the present invention may relate to an apparatus and method for detecting network security flaws in a computer network and for assessing whether a computer network complies with specific aspects of a particular operational framework. The types of computer networks which the present invention may aid in protecting or assessing include both local area and other private networks, and networks connected to the internet or a similar wide area public network.

### BACKGROUND OF THE INVENTION

Individuals responsible for securing information often deploy measures that are solution-centric (e.g., firewalls, encryption software, password tokens, etc.) without fully understanding how the overall security posture of their organization will be affected. The lack of documented security standards and regulations addressing information security issues has created an environment where security solutions or computer system architecture are driven by “industry-best standards.” In some instances the solutions may even be ad-hoc patches designed to solve individual or specific security problems.

Recently, a number of initiatives have been proposed to address the lack of standards for information assurance (IA). These regulatory initiatives include the Gramm-Leach-Bliley (GLB) Act and the Health Insurance Portability and Accountability Act (HIPAA) which requires that privacy information be protected on a given computer network. In addition, standards for corporate security are constantly being rewritten, resulting in private organizations having no operational requirements with which to implement robust security practices. Moreover, because a corporation's information assets and critical business functions are increasingly reliant upon an electronic infrastructure, every organization must answer to regulators, stockholders, customers, and partners when formulating a security policy to safeguard such assets and functions.

To accommodate internal and external standards, security requirements, and applicable laws, organizations must go through a process of translating their business needs in regard to addressing their IA standards, into a security policy statement detailing how that company will meet and comply with those standards. That same company must then implement a security program that actually complies with their security policies. Moreover, the company should routinely monitor and validate that its implemented security program is effective and continues to comply with the goals of its security policy statement as the needs of demands of the IA change, and its computer network evolves.

There are various ways a corporation can attempt to assess its compliance with regulatory standards and/or security policies. For example, a consultant can question a corporation's information officer to determine what measures that corporation has in place to safeguard its computerized information. Or the corporation can employ automated tools to perform the assessment. These automated tools include the Computer Oracle and Password System (COPS), the Security Administrator Tool for Analyzing Networks (SATAN Suite), and the Internet Security Systems (ISS) Internet Scanner. Although these automated products can scan computer infrastructures for vulnerabilities by actively probing particular aspects of the user's computer network, these public domain applications do not provide an analysis that is related to specific regulatory standards or specific security policies. Moreover, the existing automated tools lack an analytical mechanism to devise and manage such computer infrastructure scans.

Therefore, it would be advantageous if a system and method existed which provided automated prompting for, and collection of, information via an automated questionnaire. It would also be advantageous if the questionnaire was created specifically for the type of regulation or security policy employed by the user. Further, it would be advantageous if the questionnaire could be stored in a database and used with similarly situated users. It would also be advantageous if a system and method existed which contained an analytical mechanism that devised assessments of a user's computer network based on that input data. Moreover, it would be advantageous if a system and method existed which performed that assessment by scanning the user's network, thereby generating data which assessed the user's network in terms of vulnerabilities, or in terms of compliance with certain regulatory standards and security policies or operating criteria. It would also be advantageous if the generated data could be presented to the user in a various formats.

### SUMMARY OF THE INVENTION

The present invention may help to alleviate the problems discussed above and may provide a cost-effective and orderly method for assessing a user's network. In particular, the present invention may aid in providing a means for assessing a user's compliance with any type of regulatory standard, security policy, or operating criteria. For example, the present invention may permit a security manager to ascertain vulnerabilities in an existing network. The security manager may be able to accomplish this by performing the steps associated with the method of the present invention, or by using the system and apparatus of the present invention. Such a system and apparatus may, for example, be a computer system.

An apparatus according to the present invention may be described as a network assessor or a network scanner. However, the actual functions performed by the network assessor may include scanning the network, as well as assessing the network for compliance with certain operational frameworks. This network assessor may be designed to accept information from the user to aid in the scan, or the input may be automated. Such input includes the type of operational framework the user's network is operating, under. These operational frameworks include regulatory standards, security policies, or operating criteria. Other input that the network assessor will accept consists of information relating to the IP (Internet Protocol) addresses of various servers, routers, gateways, or other hardware devices on the user's network. Additionally, the inputs to the network assessor may include information relating to the types of vulnerabilities that the user wishes to be investigated, including, for example, operating system vulnerabilities, network communication vulnerabilities, and denial of service vulnerabilities.

Similarly, the input to the network scanner may include information relating to custom software applications the user wants the apparatus of the present invention to scan, as well as the frequency with which the user would like the scan to be performed. Other input information may include the time of day at which the user would like the scan to occur, as well as “black-out” periods (times and dates) related to normal business operations. The timing of the scan may be of particular importance if the network scanner is testing the user's network's vulnerabilities to denial of service attacks.

Operating system vulnerabilities that the network scanner can test for may also include providing too much information, or too high a level of privileges to users, in particular to unauthenticated users. Network communication vulnerabilities which the network scanner can test for may include susceptibility to sniffing, spoofing, or probing. Denial of service vulnerabilities which the network scanner can test for may include vulnerabilities to specific forms of denial of service, and also to the ability of denial of service attacks to disable interrelated security software or hardware.

One way that data may be input into a network assessor may be through the use of a customized questionnaire. Such a questionnaire may be provided on a traditional paper medium, or may be provided in an electronic format, for example, through an HTML interface. Once the data has been gathered, or even simultaneously as the data is gathered, the data input into the network assessor may be provided to a network scanner module. The network scanner module may accomplish a variety of tasks. For example, the network scanner module may first attempt to resolve any IP addresses if, for example, the user inputs a domain name as opposed to an IP address. The network scanner module may subsequently begin a number of other enumerative tasks which may include attempting to determine missing information, such as the identities of related systems, such as mail servers and domain name servers.

Next the network scanner module may begin its assessment and analysis of the user's network. This may include a wide variety of tasks. For example, the network scanner module may attempt to confirm that a specified system is visible or perform a TCP port scan on a visible system, or it may listen to packets on a local network in order to attempt to detect additional systems, as well as passwords or other sensitive data being passed over the user's network. Similarly, the network scanner module may attempt to authenticate itself to the user's system using that system's anticipated default settings, or it may attempt to read the media stored on the visible systems, and it may attempt to communicate with the user's system that are not visible by using a spoofing technique, such as forging header information.

In order to accomplish one or more of these assessment or scanning tasks, the network scanner module may interface with or incorporate a number of network security tools. Each of these tools may require it's own proprietary or idiosyncratic input. Similarly, each of these network security tools may provide outputs that are either too copious or cryptic to be of use to a network security manager. Therefore, the network scanner module may facilitate the scanning procedure by taking the input data in the format used by the network scanner module and converting that data into the appropriate format for use with each of the tools.

In addition, the network scanner module may collect the output of each tool and convert it into an output conforming with other outputs of the network scanner module. Thus, for example, while the native or unformatted output of ping may typically appear as shown in FIG. 5, the network scanner module may provide formatted output that may, depending on the circumstances, provide only a portion of the data provided by ping. For example, as shown in FIG. 6, individual ICMP ping results are stripped of details such as average round trip delay and timeout information, distilling the output to the core fact that a specific IP address was either “pingable” or not. Alternatively, the network scanner module may simply pass the data internally, with or without modifications to its content and/or format.

Next, the inventive system may perform a preliminary analysis based on the information input by the user and/or on the information obtained by the network scanner module. This analysis may identify potential vulnerabilities or provide additional data based on inferences from the data provided. Moreover, this analytical step may be performed on the data prior to using a scanning tool.

Finally, the inventive system may perform certain tests to determine whether there are identifiable vulnerabilities relating to the user's systems or services. These tests may, for example, employ the tools described herein, or may involve running other tests such as password attacks, denial of service attacks, or even rudimentary social engineering attacks such as sending e-mail with forged headers in an attempt to elicit information.

When the inventive system has completed its assessment, or even while it is completing its assessment, the inventive system may employ a report generator to generate a report that identifies the results of the inventive system's investigation. This generated report may include, for example, the direct output from each tool used, or the generated report may preferably provide the output in a manner that is uniform and easy to understand. For example, the program may classify and briefly list each of the potential vulnerabilities identified by the inventive system, and may associate an intuitive descriptor such as “low risk,” “medium risk,” “high risk,” “informational risk,” or “administrative risk” with each identified vulnerability. These risk levels may be further defined. For example, “high risk” may refer to vulnerabilities that could result in the user's system being immediately compromised, which, therefore, should be addressed immediately by the user. “Medium risk” may refer to vulnerabilities that could potentially result in information or system compromise, but which do not warrant immediate attention. “Informational risk” may be a specific category of “medium risk” relating to vulnerabilities that could potentially result in information compromise. “Low risk” (which may be synonymous with administrative risk) may refer to problems or warnings, such as a system configuration that might reveal information that might aid an attacker in their attempt to compromise the user's system or that would otherwise be of reconnaissance interest.

The report may also include, for example, suggestions on how to solve the identified vulnerabilities. If the report is provided as an HTML page or PDF document, the report may contain links to security patches for the operating systems and/or other software identified either by the user or by the network security testing procedure. In addition, the report may be provided as an e-mail alert, particularly if the user has selected a periodic assessment of network security.

An object of the present invention is to provide an apparatus for use as a network security device including a network parameter input module; a first network scanner module having an input in communication with an output of said network parameter input module; and a reporting module having an input in communication with an output of said first network scanner module.

An object of the present invention is to provide a method for securing a network including inputting data to a scanning module; a first step of scanning a network with a first tool of said scanning module; and presenting results from said first step of scanning.

### BRIEF DESCRIPTION OF THE DRAWINGS

FIG. 1 illustrates a diagram of a general computer system that may be used in conjunction with the present invention;

FIG. 2 illustrates a flow diagram of an embodiment of the present invention;

FIG. 3 illustrates a flow diagram in an alternative embodiment of the present invention;

FIG. 4 illustrates a diagram of the scanning apparatus that may be used in conjunction with the present invention;

FIG. 5illustrates the output of a “ping” from two different operating systems;

FIG. 6 illustrates an XML document containing the normalized version of the native output shown in FIG. 5; and

FIG. 7 illustrates the environment database 440 shown in FIG. 4.

### DETAILED DESCRIPTION

In conjunction with the filing of this application, there is simultaneously filed a co-pending application entitled “Methods and Systems for Assessing and Advising On Electronic Compliance,” (Attorney Docket No. 01619.0002) which the U.S. Patent Office assigned Ser. No. 10/___,___, and which is expressly incorporated herein in its entirety.

It is to be understood that the terminology used herein is for the purpose of describing particular embodiments only, and is not intended to limit the scope of the present invention.

It should be understood that throughout this disclosure, the singular reference may include the plural and the plural may include the singular. For example, “results” may refer to a single result and “data” may refer to a single, discrete item of data, or to numerous items of data. Moreover, words employed herein are in accordance with their normal usage within the relevant art, unless otherwise indicated by express indication or context. Additionally, conjunctions as used herein are generally used in a conjunctive and not disjunctive sense. For example, “or” carries the same connotation as the logical expression “or” and not the logical expression “exclusive or.” Preferred methods, devices, and materials are described herein, but, as one skilled in the art will recognize, similar or equivalent methods, devices, and materials may be used without deviating from the teachings of the specification. All patents, patent applications or publications referenced herein are incorporated hereby in their entireties, however, any reference to such patents, patent applications or publications should not be construed as an admission that they constitute prior art.

### Descriptions of Illustrative Embodiments of the Invention

One embodiment of the present invention may take the form of an assessment apparatus and methods for use in assessing specific attributes of computer networks. In particular, the present invention may relate to an apparatus and method for detecting network security flaws in a computer network. In particular, the present invention may also relate to assessing the whether the user's network complies with the specific aspects of a particular operational framework. The assessment apparatus can include a network parameter input module and a first network scanner module, which receives as input, the output of the network parameter input module. A further embodiment of the present invention may also include a second network scanner module which operates like the first scanning module. The output of both the first scanning module and the second network scanner module are in communication with an input of the reporting module.

In a particular embodiment of the present invention, the network parameter input module includes and/or uses data input by a user. In another embodiment of the present invention the network parameter input module includes and/or uses data responsive to a questionnaire, or data which is input by an automated process.

In a further embodiment of the present invention, the network parameter input module includes an error checking module to assess the validity of the provided data. In another embodiment of the present invention, the network parameter input module includes a database of network addresses, and/or a database of user names, which can be input into the first and/or second scanning module automatically, or manually. In a further embodiment of the present invention, the network parameter input module includes a parameter settings database. Such a parameter settings database may include data relating to one or more parameters such as network addresses, addresses, network blocks, vulnerabilities of interest, tools to be used for vulnerability detection, maximum tolerances, time of day availability for program execution, scan blackouts (times of day or date ranges) or frequency of operation.

In another embodiment of the present invention, the first network scanner module includes at least one of many network scanning tools which accept input and generates output.

In yet another embodiment of the present invention, the first network scanner module includes a module adapted to create a scan list based on data from the network parameter input module. In another embodiment of the present invention, the first network scanner module includes a module adapted to create an inventory of exposed systems on a network. In a further embodiment of the present invention, the first network scanner module includes a module adapted to create an inventory of exposed services on a network.

In a particular embodiment of the present invention, the first network scanner module includes a module adapted to analyze results of probing a network. In another embodiment of the present invention, the first network scanner module includes a module adapted to probe a system to make a status determination regarding identifiable vulnerabilities. In another embodiment of the present invention, the reporting module includes a wrapper module, which is to receive data in one or more formats, and output that same data in a uniform format.

In an embodiment of the present invention, the reporting module includes a client environment database. The client environment database may include tables which store data which is generated by various scans. Such data stored in the tables of the client environment database includes: scan parameters used in scanning, operating systems, IP registry, IP address universe (an indicator for differentiating between different networks which use the same “private” IP address blocks), vulnerabilities, scan time, last scan date, next scan date, status of network, discovered media access control (MAC) addresses (e.g., Ethernet addresses), scan activity log, exposed systems, exposed services, scanned domain names, scanned IP, discovered IP, or applications used in scanning.

In another embodiment of the present invention, the network parameter input module may be adapted to infer network testing parameters based on a compliance regime input by a user. Such a compliance regime may, for example, be one of the following: an industry standard, a corporate regulation, or a governmental regulation.

One embodiment of the present invention includes a method for securing a network including the steps of inputting data into a scanning module, the step of scanning a user's network with a first tool of the scanning module, and presenting the results from the scanning step to the user or to another module. A further embodiment of the present invention may include an additional step of scanning a network with an additional tool of the scanning module. In another embodiment of the present invention, the step of inputting data into a scanning module includes the inputting of user data either automatically or manually. In another embodiment of the present invention, the step of inputting data into the scanning module includes the data being generated by the user in responding to a questionnaire. In a further embodiment of the present invention, the step of inputting data into the scanning module includes checking the data for errors.

In yet another embodiment of the present invention, the step of inputting data includes providing input from a database of network addresses. In an embodiment of the present invention, the step of inputting data into the scanning module includes providing input from a database of user names. In another embodiment of the present invention, the step of inputting data into the scanning module includes providing input from a parameter settings database. Such a parameter settings database may include data relating to one or more parameters such as network addresses, MAC addresses, network blocks, vulnerabilities of interest, tools to be used for vulnerability detection, maximum tolerances, time of day availability for program execution, or frequency of operation.

In another embodiment of the present invention, the scanning step includes creating a scan list based on data from the network parameter input module. In another embodiment of the present invention, the scanning step includes creating an inventory of exposed systems on a network. In a further embodiment of the present invention, the scanning step includes creating an inventory of exposed services on a network.

In yet another embodiment of the present invention, the scanning step includes analyzing results of probing a network. In another embodiment of the present invention, the scanning step includes probing a system to make a status determination regarding identifiable vulnerabilities. In another embodiment of the present invention, the results of previous scan activities may be analyzed and correlated in order to determine additional information or vulnerabilities of a system or network. In another embodiment of the present invention, the step of presenting results includes wrapping or formatting the output data which is in one or more formats, into one common or uniform format.

In a further embodiment of the present invention, the step of presenting results includes generating or populating a client environment database with the data generated or output by one or more scans. Such a client environment database may include or be populated with data corresponding to one or more of the following: scan parameters used in scanning, operating systems, IP registry, vulnerabilities, scan time, last scan date, next scan date, status of network, discovered MAC addresses, scan activity log, exposed systems, exposed services, scanned domain names, scanned IP, discovered IP, or applications used in scanning.

In another embodiment of the present invention, the step of inputting data includes inferring network testing parameters based on a standard or compliance regime input by a user. In a further embodiment of the present invention, the standard or compliance regime is selected from a group consisting of a regulatory standard, a security scheme or a security policy.

Reference may now be made to the embodiments of the present invention illustrated in the accompanying drawings. When possible and practical, the same reference numbers are used throughout the drawings to refer to the same or like parts or steps.

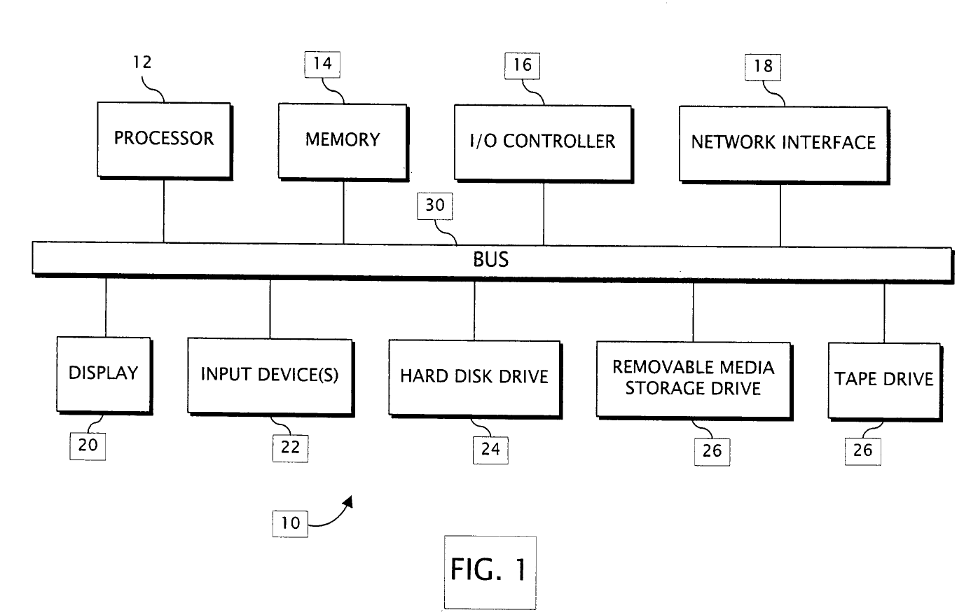

Referring to FIG. 1, the general purpose computer system 10 on which the assessment system disclosed herein is run includes a central processor 12, a main memory unit 14 for storing programs and/or data, an input/output controller 16, a network interface 18, a display device 20, one or more input devices 22, a fixed or hard disk drive unit 24, a removable media storage drive (e.g., floppy disk drive, compact disk (CD) drive, etc.) 26, a tape drive unit 28, and a data bus 30 which couples these components so as to allow communication there between as well as communication with other computer systems. Such communication occurs either via direct connection, via the world wide web, or via other means of communication such as cable, phone lines, microwave and wireless communication.

The central processor 12 can be any type of microprocessor, such as a PENTIUMTM™ processor, made by Intel of Santa Clara, Calif. The display device 20 can be any type of display, such as a printer, or a liquid crystal display (LCD), cathode ray tube display (CRT), light emitting diode (LED), plasma gas (PG), and the like capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the computer system 10 to connect to a computer network such as the Internet and/or connect with another computer system upon which the systems and methods of the inventions disclosed herein can be practiced.

Those skilled in the art will appreciate that computer systems 10 embodying the present invention need not include every element shown in FIG. 1, and that equivalents to each of the elements are intended to be included within the spirit and scope of the invention. For example, the computer system 10 need not include the tape drive 28, and may include other types of drives, such as CD or digital video disk (DVD) drives. CD drives can, for example, be written to and read from, thereby storing some or all of the data in the databases described herein.

In at least one embodiment of the present invention, one or more computer programs define the operational capabilities of the computer system 10. These programs can be loaded into the computer system 10 in many ways, such as via the hard disk drive 24, the media storage drive 26, the tape drive 28, or the network interface 18. Alternatively, the programs can reside in a permanent memory portion (i.e., a read-only-memory (ROM) chip) of the main memory 14. In another embodiment, the computer system 10 can include specially designed, dedicated, hard-wired electronic circuits that perform all functions described herein without the need for instructions from computer programs.

In at least one embodiment of the present invention, the computer system 10 is part of a client-server system, in which a client sends requests to a server and a server responds to requests from a client. Of course, a “client” can be broadly construed to mean one who requests or gets the file, and “server” can be broadly construed to be the entity that downloads the file. Basically, the computer system 10 can be either a client system or a server system. In one embodiment, the invention is implemented at the server side and receives and responds to requests from a client, such as a reader application running on a user computer.

The client can be any entity, such as the computer system 10, or specific components thereof (e.g., terminal, personal computer, mainframe computer, workstation, a wireless hand-held device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC.RTM., PENTIUM-based, or RISC-based, that includes an operating system such as IBM.RTM, LINUX, OS/2.RTM, or MICROSOFT WINDOWS (made by Microsoft Corporation of Redmond, Wash. and that includes a Web browser, such as MICROSOFT INTERNET EXPLORER, NETSCAPE NAVIGATOR (made by Netscape Corporation, Mountain View, Calif., having a Java Virtual Machine (JVM) and support for application plug-ins or helper applications. A client may also be a notebook computer, a handheld computing device (i.e., a PDA), an Internet appliance, a telephone, an electronic reader device, or any other such device connectable to the computer network.

The server can be any entity, such as computer system 10, a computer platform, an adjunct to a computer or platform, or any component thereof, such as a program that can respond to requests from a client. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions and the like.

Embodiments of the invention can be implemented using computer technologies such as software applications, computer-readable program media, data structures, carrier wave signals, user interfaces, and application program interfaces. For example, software embodying the present invention in one embodiment, resides in at least one application running on the computer system 10. In at least one embodiment, the present invention is embodied in a computer-readable program medium usable with the computer system 10. In at least one embodiment, the present invention is embodied in a data structure stored on a computer or a computer-readable program medium. In addition, in one embodiment, the present invention is embodied in a transmission medium, such as one or more carrier wave signals transmitted between the computer system 10 and another entity, such as another computer system, a server, a wireless network, etc. One embodiment of the present invention also can be embodied in an application programming interface (API) or a user interface. In addition, the present invention, in one embodiment, is embodied in a data structure.

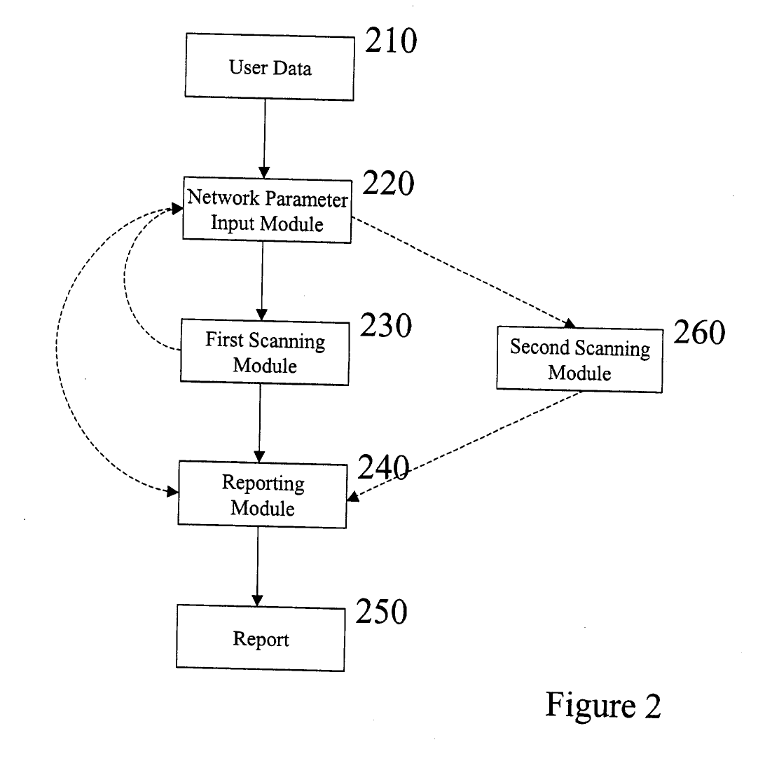

As shown, for example, in FIG. 2, an embodiment of the present invention may include a network parameter input module 220, a first network scanning module 230, and a reporting module 240. The apparatus according to the present invention may also optionally include additional network scanning modules, which are referred herein as the second network scanning module 260. In the course of operating the apparatus of the present invention, user data 210 may be supplied to the network parameter input module 220. The user data 210 may be input manually by a user, or automatically by the apparatus of the present invention. The user data 210 may include domain names, IP addresses, host names, user names, passwords, software specifics, hardware specifications and other network specific information. The user data 210 may also contain information relating to scanning, such as the time of day at which the scan is to be performed, the frequency with which the scan is to be performed (e.g. one time or periodically), and the types of vulnerabilities which the user hopes to identify.

User data 210 may be supplied by manual entry by an operator of the present invention, or may be supplied through an on-line or other interactive interface, for example, a web-page or HTML interface. In one aspect of the present invention, user data 210 may be supplied by providing the user with an interactive questionnaire. Accordingly, the interactive questionnaire may guide the user's input of the user data 210. These types of input modes are discussed in the co-filed and co-pending application.

Certain data may require interpretation. For example, the user may indicate that he wishes to identify whether his network complies with a particular operating framework. As disclosed in the co-pending application, an operating framework can include, but is not limited to at least one of, a regulatory standard, a security scheme, and a security policy. The network parameter input module 220 may be adapted to use the information provided by the user or the system to infer a set of tests to be performed that probe for specific vulnerabilities. Such tests can be inferred, for example, by first, identifying the operating framework the user seeks to assess compliance against. Then the parameters that need to be tested or probed for a given operating framework are placed in a look-up table such as a “Decision Tree” which is indexed by the operating framework. In one aspect of the present invention, any “new” information generated as a result of the performed tests may cause additional scanning modules to be employed. Additionally, the identification of a particular operating framework may serve to aid in deciding the appropriate format of the report to be generated.

According to the principles of the present invention, the decision tree may comprise an XML document and describe the logical flow of activities performed during a particular assessment scan as well as the use of particular tools during the scan. In one aspect of the present invention, the decision tree may describe the flow of scanning activities based both on user-provided parameters as well as results from the tools as they are returned. In one aspect of the present invention, the decision tree may break up the logical flow of a particular assessment scan into a plurality of serially executable phases including an enumeration phase, a public information phase, an inventory phase, an analysis phase, and a vulnerability phase, wherein each phase may have at least one task (e.g., activity) associated with it. Accordingly, the decision tree may describe conditions prerequisite to the use of any scanning tool. For example, if it is determined that a system is running a web server or some port, the server may be profiled and the vulnerability phase may be performed.

During the enumeration phase, a scan list containing IP addresses that need to be scanned is generated based on information (e.g., IP addresses, domain names, network blocks, etc.) provided by the user data. In one aspect of the present invention, the scan list may be generated by expanding CIDR blocks and resolving domain names.

During the public information phase, queries of public databases (e.g., DNS, WhoIs, etc.) may be performed regarding the network/system to be scanned.

During the inventory phase, the user's network may be scanned to determine which systems and services are running and are publicly available from the Internet. Alternatively, if the scan is performed from within a private or protected network, the inventory phase will determine which systems and services are accessible from the location of the scanner within that network. Accordingly, during the inventory phase of the assessment scan, multiple pinging, port scanning, banner grabbing, service probing, etc., may be performed to gather information regarding exposed systems and services on the user's network.

During the analysis phase, the existence of vulnerabilities may be determined by analyzing data stored in the environmental database 330. For example, exposed ports may lead to a conclusion as to whether a firewall is present, or parsing of application banners may strengthen conclusions about the presence of operation system versions or specific application protocols. Further, subsequent analysis of exposed systems may be performed by combining results of the various used tools. For example, each banner may provide a clue to the actual operating system. In another example, it may be possible to determine the type of system that was detected by analyzing the collection of network services that it offers.

During the vulnerability phase, the exposed systems and services are tested to determine the existence of identifiable vulnerabilities. In one aspect of the present invention, the vulnerability phase may run tests against applications and protocols, not TCP/UDP port values.

In one aspect of the present invention, the decision tree may also include resource information indicating the operating system a particular tool runs on. This capability would increase the number of tools which could be used by the scanner.

Once the network parameter input module 220 has sufficient input allowing it to determine what scan and tests need to be run, it can then begin the data collection by scanning the user's network. For example, the user may input via the user data 210 supplied to the network parameter input module 220 and the domain and host names of the network. The network parameter input module 220 may then seek to determine their IP addresses by calling a first scanning module 230. When called by the inventive scanning apparatus, the first scanning module 230 provides the IP address by, for example, requesting the IP address from a domain name server (DNS). The first scanning module 230 may accomplish this task using a scanning tool, such as “dig” or “nslookup.” Other scanning tools discussed herein and in the co-pending application may also be employed.

Once the network parameter input module 220 has collected all the data that can be discerned from the parameters in the look-up table, the inventive scanning apparatus will have sufficiently described the network environment it intends to test. Once the user's system is sufficiently described, the inventive scanning apparatus can perform a preliminary analysis. This preliminary analysis may indicate certain forms of attack which should be used to test the user's network. For example, if the available information shows a Microsoft NT ® network, certain tests, both proprietary and publicly known, may be used to attempt to exploit known vulnerabilities in NT networks. In particular, the QTIP program may be designed to attempt to try the default “null” username for an Windows NT/2000/XP server.

When the network parameter input module 220 has completed at least a portion of its preliminary analysis, it may call a first scanning module 230, to perform a scan of the user's network. The operation of the first scanning module 230 is more fully described below. In order to perform the scan of the user's network, the network parameter input module 220 may supply the appropriate parameters for each scan to the first scanning module 230. Depending on the results of the scan generated by the first scanning module 230, the network parameter input module 220 may call for additional scans of the user's network, or the network parameter input module 220 may input the scan data to the reporting module 240.

The reporting module 240 may in one embodiment be a submodule of the network parameter input module 220. Thus, the reporting module 240 may be in communication with a first scanning module 230, a second scanning module 260, and/or the network parameter input module 220. The reporting module 240 may organize and assemble the information collected by the network parameter input module 220 and scanning modules 230 and 260 to provide a report 250 based on the scan data generated by those modules 220, 230, 260. The reporting module 240 and network parameter input module 220, may, for example, be accomplished by software programmed in XML. One reason XML may assist in the present invention is that it permits the exchange of data that is specially formatted, independent of the presentation of that data. Thus, it may be a preferred embodiment of the present invention to format the data input into the scanning modules 220, 230, and 260 in a common factor, as well as formatting the output. As discussed in the co-pending application, the report 250 may be in a uniform format, and may, for example, detail the user's network's compliance or non-compliance with each particular requirement of the applicable operating format. The report 250 could alternatively list vulnerabilities, and associate a level of seriousness with each identified vulnerability.

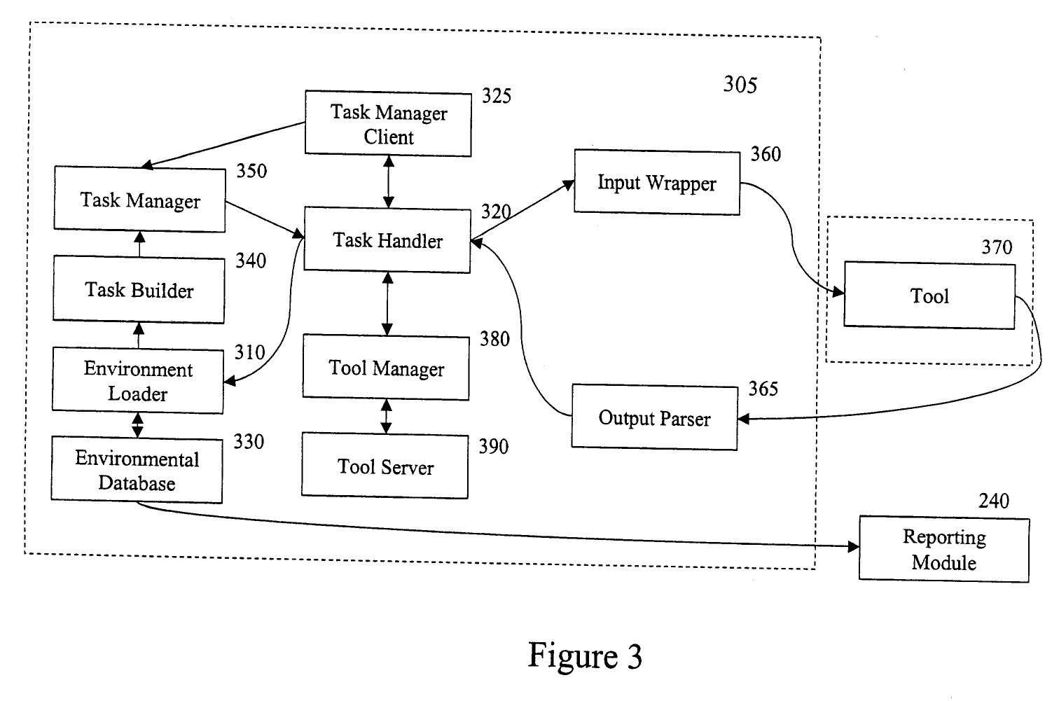

As shown in FIG. 3, an alternative embodiment of the present invention may include an assessment module 305, similar to the network parameter input module 220 of FIG. 2, a scanning tool 370, similar to the scanning modules 230 or 260 of FIG. 2, and a reporting module 240, substantially the same as the reporting module of FIG. 2.

The assessment module 305 may include a task manager 350, a task builder 340, an environment loader 310, an environmental database 330, a task handler 320, a task manager client 325, a tool server 390, a tool manager 380, an input wrapper 360, and an output parser 365. The assessment module 305, in conjunction with the scanning tool 370, performs a second phase of a network assessment, which consists of scanning the user's network to determine its level of compliance with a given operating framework. Alternatively, the second phase of a network assessment may be performed using the assessment module 305, in conjunction with the first scanning module 370, to determine the user's network's level of vulnerability. In another alternative aspect of the present invention, the second phase of the network assessment may be performed to validate that a previously identified problem or vulnerability has been solved (e.g., that a vulnerable service has been patched, that an unnecessary service has been removed or blocked, etc.).

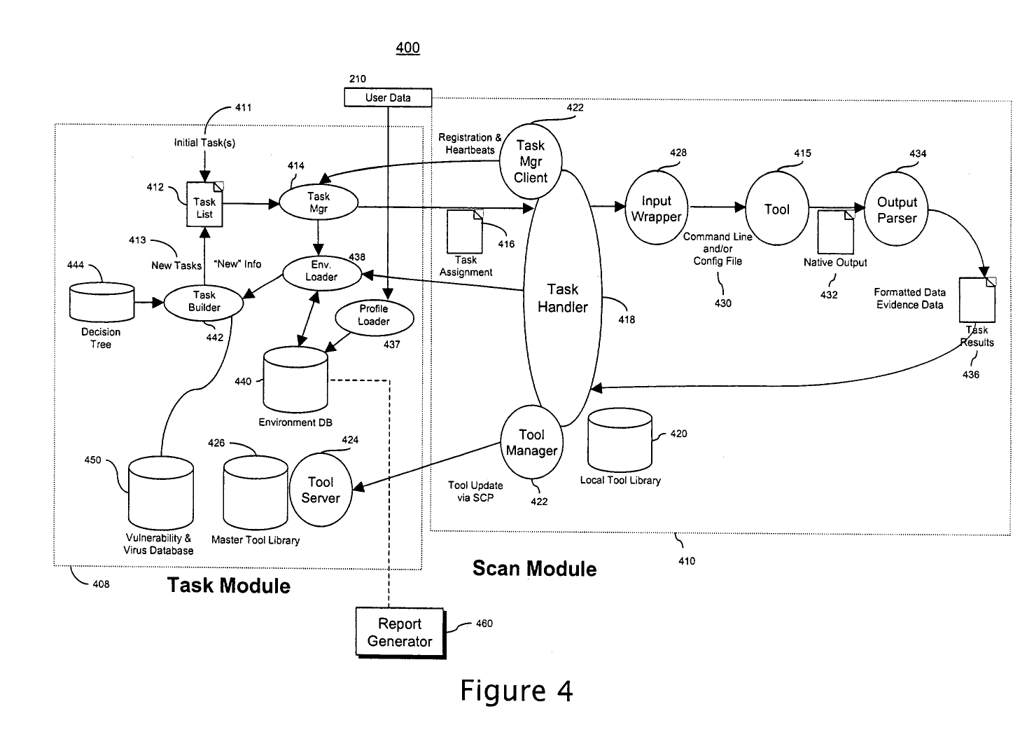

An alternative embodiment of the network assessment system disclosed in FIG. 2 and in FIG. 3 is disclosed in FIG. 4.

Referring to FIG. 4, the operation of the scanning apparatus 400 disclosed in FIG. 4 may be similar to the operation of the assessment module 305, in conjunction with the first scanning module 370 of FIG. 3, in that the scanning apparatus 400 performs the second phase of a network assessment. Accordingly, the second phase of a network assessment may consist of employing the scanning apparatus 400 to scan the user's network to determine its level of compliance with a given operating framework, to determine the user's network's level of vulnerability, or to validate that a previously discovered problem has been solved (e.g., that a vulnerable service has been patched, that an unnecessary service has been removed or blocked, etc.).

According to the principles of the present invention, the scanning apparatus 400 may be grouped into two modules: a task module 408 and a scan module 410. In the preferred embodiment of the present invention, the scanning apparatus 400 begins when user data 210 (e.g., IP addresses, domain names, blackout dates, etc.) is inputted by a user into the profile loader 437 which then deposits the user data 210 into the environment database 440. Next, an initial task or tasks 411 are generated, wherein the initial task(s) 411 may comprise general instructions required by the scanning apparatus 400 to begin scanning the user's network. In one aspect of the present invention, the initial tasks may comprise instructions such as “load the scan parameters”, and the like. The initial task(s) 411 may be stored in a task list 412, that may be read and processed by the task manager 414. In one aspect of the present invention, the task list 412 may be initially processed such that the initial task(s) 411 instruct the task manager 414 to load environment data (e.g., the user data 210 ) into the environment loader 438. In another aspect of the present invention, each phase of the Decision Tree 444 can have its own initial task such that the particular phase of the Decision Tree may be “bootstrapped” upon processing of the task list 412.

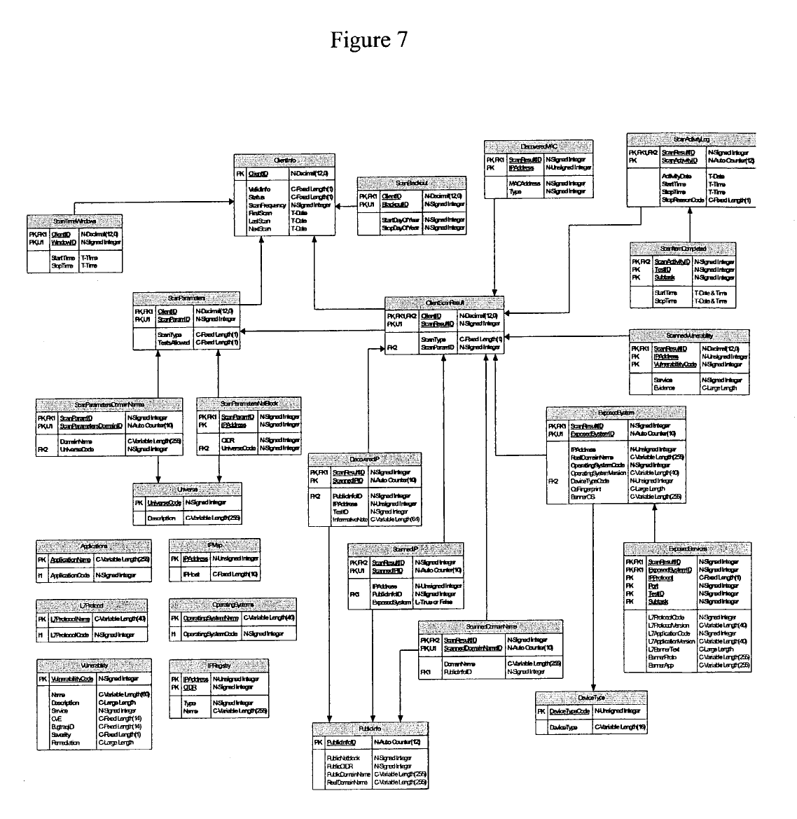

The environment loader 438 then retrieves environment data specific to the user's network from the environment database 440. In one aspect of the present invention, the environment database 440, which can also be referred to as a client environment database (CED), may be written in substantially any database management software known in the art, including SQL. In one embodiment of the present invention, the CED may contain multiple sections. FIG. 7 illustrates an exemplary internal structure of the CED shown in FIG. 4.

Referring to FIG. 7, one section of the CED (e.g., in ScanParameter, ScanParameterDomainName, and ScanParameterNetblock tables) may contain the scan parameters for a user's network, such as IP addresses and network blocks, and server domain names, that instruct the scanning apparatus 400 which server(s) to scan. The CED may also contain blackout information in tables such as the ScanBlackout and ScanTimeWindow tables, providing guidance for when scan activities should and should not be performed. In one aspect of the present invention, the blackouts may be used to allow a user to specify times of day (e.g., normal business hours) and seasons (e.g., Thanksgiving through Christmas for an e-merchant) when scans should not be performed. Alternatively, the CED may contain times and dates which describe allowable windows for the scan. Another section of the CED may, for example, contain the scan list (e.g., in table ScannedIP), containing all of the IP addresses that are to be scanned. Accordingly, the scan list may, for example, be formed by expanding CIDR/network blocks into their constituent addresses, or from DNS resolution of domain names. In one aspect of the present invention, the scan list may be built from results obtained by predetermined scanning tools (e.g., CIDR expanders, DNS resolvers, etc.) and derived from the user data.

Referring still to FIG. 7, the CED may include a ClientInfo table containing information regarding each client (e.g., client's name, affiliation (e.g., partner program, standards association, etc.), indicators indicating whether the client is part of a larger enterprise (e.g., a state agency, division within a larger company, etc.)) In one aspect of the present invention, the CED may include also information related to past and future scans of a particular user. In another aspect of the present invention, the tables in FIG. 7 may include data regarding the scan parameters, the scan frequency, the time for each scan, the scan result, the start time for a particular scan, the stop time for a particular scan, the next scan date, the status of the scanned network, discovered MAC addresses, scan activity log, exposed systems, exposed services, scanned domain names, scanned IP addresses, discovered IP addresses, and applications used in scanning.

According to the principles of the present invention, the ClientInfo table may describe the client and is the source of the critical ClientID key that ties together the scan parameter tables with the scan results tables. When a scan is started, a new row in the ClientScanResult table is created. The new row may contain a reference back to the client (ClientID) and the current set of scan parameters (ScanParamID) such as CIDR blocks and domain names. All of the tables that contain results of the tools (e.g., ScannedIP, ExposedSystem, ExposedService, ScannedVulnerability, DiscoveredIP, etc.) may all be tied together by the new ScanResultID key, which has it's root in the ClientScanResult table.

In one aspect of the present invention, the environment loader 438 knows which data to retrieve from the environment database 440 for any number of reasons. For example, if, from the user data 210, the scanning apparatus 400 determines that the user is employing a system similar to another system previously scanned, the task manager 414 will instruct the environment loader 438 to load specific environment data from the environment database 440. Alternatively, as discussed herein and in the co-pending application, environment data input directly by the user (e.g., as user data 210 ) in response to inquiries tailored to the user's network and operating framework could result in the task manager 414 instructing the environment loader 438 to load generic data such as IP addresses, domain names, blackout dates, desired scan tests to perform, etc.

In one aspect of the present invention, the scan profile loader 437 may contain a security device capable of preventing restricted systems or information from being scanned. In one embodiment, this security device may comprise a collection of IP addresses indicating where the tool 415 is prohibited from investigating. The scan profile loader 437 accesses the security device prior to beginning the scan. If the security device determines that the IP address should not be evaluated, an alert may be provided to system operators and the scan is put “on hold” until it has been remediated. Accordingly, it may be determined whether a user has provided incorrect or malicious scan parameters or too many addresses for their service level. In one aspect of the present invention, the security device may be implemented as a “pre-filter,” before the data is loaded into the CED or as an initial tool capable of being used upon scanning. In another aspect of the present invention, the security checks may, for example, include forbidden IP's and domain names (i.e., US military ranges, .mil domain names, etc.), as well as a check to see if a user is requesting the scan of a network already specified by another user in their own scan parameters.

Conversely, if the security device determines that the IP address(es) can be scanned, then the scan module 410 proceeds as described herein. The security device also prevents the system from scanning particular domain names and IP addresses so as to prevent a search or scan of restricted sites. For example, if the security device contains a domain name with the extension “.mil”, the compliance assessment system can be instructed to not scan that site.

After the environment data has either been retrieved from the environment database 440 and loaded onto the environment loader 438, or after the data is loaded directly onto the scan profile loader 437 as user data 210 to start the scanning process, the initial environment data (or user data) is passed to the task builder 442. Upon receiving the data, the task builder 442 builds a task list 412 containing new tasks 413 which the scanning apparatus will employ to scan the user's network. In the preferred embodiment, the task builder 442 may employ a decision tree 444, similar to the decision tree described above, to aid in deciding which tasks need to be performed in order to complete that scan. Accordingly, the decision tree 444 aids the task builder 442 in adding any necessary tasks to the task list 412 by specifying initial tasks which must be performed on the scan parameters as well as new tasks which should be performed based on the results of the initial and subsequently generated tasks. In one aspect of the present invention, the decision tree 444 may perform substantially the same actions that a human analyst would perform and dictates the data-driven sequence of scan and analysis activities. For example, the decision tree may specify what tasks are to be performed if a web server is identified by a specific tool. Accordingly, the task list 412 may be dynamically built, based on results of initial and subsequently performed tasks.

Once the task list 412 is complete, and/or a predetermined number of tasks have been added to the task list 412, and/or a specific pre-selected task has been added to the task list 412, the task list 412 is passed to the task manager 414. Upon receiving the task list 412, the task manager 414 may sort the tasks on the task list 412 according to a given system priority.

Once the task manager 414, prioritizes the order of the tasks to be performed, the task manager 414 begins passing task assignment(s) 416 to one or more task handlers 418. In one aspect of the present invention, each task assignment 416 may comprise at least one task within the task list 412 to be performed during a scan. Other specific tasks ordered by the task manager 414 may, for example, include listening to a user's network to detect passwords or other sensitive data being passed over that network, reading media stored on visible systems, and communicating with systems that are not visible using a spoofing technique, which includes forging header information.

In the preferred embodiment, one or more task handlers 418 may be in communication with the task manager 414. Before any tasks can be assigned to a task handler 418, the task handler client 422 must register with the task manager 414, informing it of the types and quantities of tasks that the task handler 418 can perform. The task handler client 422 may also send periodic status messages to the task manager 414, indicating overall performance of the task handler 418. Accordingly, the task handler 418 may be provided as a “server” process (in TCP/IP terms) that listens for task assignments 416 from the task manager 414. During the operation of the scanning apparatus 400, the task handler 418 may, for example, receive the title of each task assignment 416 being handled by the task handler 418 and keep track of its operation. Results of each task assignment may then be returned to the task manager 414 by the responsible task handler 418. According to the principles of the present invention, multiple task handlers 418 may be available to perform task assignments for the task manager 414 at any given time. In this way the task manager 414 and the task handler(s) 418 to form a scalable scanning architecture as described in more detail below.

Once the task handler 418 receives the task assignment 416 from the task manager 414, the task handler 418 initiates the scanning process. In order to perform a scan (or any other probing or analytic task), the proper scanning tool 415 must be selected. In one embodiment of the present invention, the task handler 418 may access one or more tools 415 stored in the master tool library 426 via the tool server 424. The master tool library 426 contains tools written in various programming languages so as to accommodate the various systems scanned by the scanning engine 410, as well as the different host operating systems that serve as task handlers 418. Once the task handler 418 determines which tools 415 it needs to employ in order to conduct the scan of the user's network, the task handler 418 instructs the tool manager 422 to retrieve from the master tool library 426, via the tool server 424, those tools needed to perform a given scan. Once the tool manager 422 retrieves the needed tools 415 it stores them on the local tool library 420. In the preferred embodiment certain tools 415 are stored in a local tool library 420 according to the operating system upon which they run. Accordingly, all the tools 415 which operate on a UNIX platform may be stored in a first local tool library, while tools operating in a Windows environment might be stored in a second tool library. Alternatively, the tools 415 could be stored in a local tool library 420 according to the tasks they perform. In another embodiment, the scanning module 410 can employ multiple local tool libraries 420, which are grouped as discussed above, thereby eliminating the need to retrieve the tools from the master tool library 426.

The actual functions performed by scanning tools 415 can be grouped as follows: public information queriers (e.g. domain name resolvers, etc.); host scanners, port scanners,specific vulnerability determiners, and data analysis functions (e.g., TCP/IP port correlation or service banner parsing and analysis). Moreover, scanning tools 415 may be created for a specific function, or they may be a conglomeration of various other scanning tools 415 available in the public domain and custom designed tools, as listed in Table 1. The scanning tools listed in Table 1 is not meant to be exhaustive.

TABLE 1

| Tool | Source | Description | Input | Results/Output |
|---|---|---|---|---|
| ping | Unix | ICMP echo request | IP address or | IP address (HOST |
| | command | (“ping”) probe to | CIDR block | record) echoed back if |
| | | determine if an IP address | | system is up. |
| | | is active. | | |
| nmap | Open source | Used for two purposes. | IP address or | Case I: IP (HOST |
| | | First, to determine if a | CIDR block | record) echoed back if |
| | | host is up (complements | | system is up. |
| | | ping) by checking about | | Case II: List of open |
| | | 20 ports on the user's | | TCP PORTS. |
| | | system. Useful for | | |
| | | detecting systems that do | | |
| | | not respond to ping. | | |
| rpcinfo | Unix | Detects Unix/Sun RPC | IP address | List of dynamic ports |
| | command | portmappers on UDP port | | and their RPC program |
| | | 111. | | numbers if this service is |
| | | | | up. |
| Dig | Unix | Detects DNS servers on | IP address | PORT record returned if |
| | command | UDP port 53 (“any” | | valid response received. |
| | | records). | | |
| Dig | Unix | Detects DNS servers | Second level | Zone information. |
| | command | offering zone transfers | domain and IP | |
| | | (“axfr” records) on TCP | address of | |
| | | port 53. | DNS server | |
| Dig | Unix | Performs address lookups | Second level | IP address and note |
| | command | (“A” records) of common | domain names | regarding type of record. |
| | | third-level domain names | | |
| | | (i.e., www, mail, ns, etc.) | | |
| | | in order to identify | | |
| | | “related” computers not | | |
| | | specified by the client. | | |
| onesixtyone | Open source | Detects if SNMP agent is | IP address | Guessed community |
| | | running on UDP 161. | | string (like a password) |
| | | | | and system ID info (OS, |
| | | | | etc.). |
| Ntpq | Open-source | Detects if the Network | IP address | Acknowledgement of |
| | | Time Protocol is running | | protocol and list of NTP |
| | | on UDP port 123. | | peers. |
| pptp_probe | Proprietary | Gets hostname and | IP address | Hostname and vendor |
| | | vendor information for a | | name (e.g., “Cisco” or |
| | | PPTP-based VPN server | | “Microsoft”). |
| | | running on TCP port | | |
| | | 1723. | | |
| nmblookup | Unix Samba | Checks for NetBIOS | IP address | NetBIOS name (i.e., |
| | client (open | name service on UDP port | | Microsoft network |
| | source) | 137, indicating either | | system name) and |
| | | Microsoft networking or | | workgroup/domain name |
| | | Samba server. | | if present. |
| smbclient | Unix Samba | Gets additional NetBIOS | IP address | List of NetBIOS names, |
| | client (open | share names, etc. from | | including information on |
| | source) | TCP port 139. | | whether the system is a |
| | | | | Windows a domain |
| | | | | controller, master |
| | | | | browser, etc. |
| qtip | Proprietary | Advanced Microsoft “null | IP address | Success indicator, as |
| | | account” login prober. | | well as specific evidence |
| | | | | of configuration policy |
| | | | | problems (e.g., |
| | | | | accessible list of user |
| | | | | names, share names, |
| | | | | security policy problems, |
| | | | | etc.). |
| gbg | Proprietary | Grabs “banners” in order | IP address and | Text string as extracted |
| (“generic | | to identify specific | TCP/UDP port | by the prober. |
| banner | | applications (i.e., is the | number | |
| grabber”) | | web server Apache or | | |
| | | Microsoft IIS). | | |
| Dotmatrix | Proprietary | Intellegent, modular, | IP address and | Text string of banner and |
| | | protocol-smart banner | TCP/UDP port | identification of |
| | | grabber. | number. | application layer |
| | | | | protocol (e.g., HTTP, |
| | | | | Telnet, etc.). |
| wget | Open-source | Used to retrieve the | IP address and | The title of the default |
| | | index.html page from a | port number | web page. |
| | | web server in order to | | |
| | | extract the title of the | | |
| | | default web page. | | |
| nikto | Open-source | CGI scanner for a web | IP address and | Certificate information |
| | (www.cirt.org) | server. Works with both | port number | and (sometimes very |
| | | HTTP and HTTPS. Also, | | long) list of suspicious |
| | | extracts certificate | | files on a web server. |
| | | information from an https | | |
| | | SERVER. | | |
| nessus | Open-source | Generic vulnerability | IP address, | Vulnerability code and |
| | (with a few | scanner. | protocol | any specific evidence |
| | proprietary | | (UDP/TCP and | [information the tool |
| | plugins) | | a port number | provides about that |
| | | | | vulnerability (e.g., |
| | | | | sample data, usernames, |
| | | | | etc.). |
| Dorian | Proprietary | Framework for | IP address and | Various results based on |
| | | performing custom web | port number of | specific analyis |
| | | application analysis. | web server. | configurations. |
| | | | Application- | |
| | | | specific | |
| | | | parameters if | |
| | | | known. | |

Although not required, typically each of the tools 415, including the tools 415 listed in Table 1, has inputs and outputs associated with it. For example, the scanning tool “ping” may require an IP address and may return the IP address of the computer system that was pinged if the targeted system is up, reachable, and responding to ICMP pings. Similarly, the tool “nmap” may require an IP address or CIDR block, and may provide a list of open TCP Ports for each IP address specified as input. Another tool 415 “rpcinfo” may require an IP address to be input, and may provide back a list of dynamic ports and their RPC program numbers (if RPC is not disabled). Another example tool 415 “dig” may require an IP address or second level domain name to be input, or require a second level domain and IP address of the DNS server to be input, and may output a Boolean indicator (i.e., true) if a DNS server is detected on UDP port 53. Alternatively, the tool “dig” may output DNS zone information if a DNS server is detected on TCP port 53 and responds to the “zone transfer” command. Similarly, the tool 415 “dig” will alternately provide other information on other related systems, based on common third level domain names such as “www”, “mail”, or “ns”, as well as specific probes for domain information such as authoritative domain name servers, mail exchangers, etc.

Another tool 415, “onesixtyone”, may require an IP address to be input, and may detect and report on whether it senses any SNMP activity on UDP port 161. For example, “onesixtyone” may report that a SNMP agent is running on UDP 161, and may report on any guessed community strings or system ID information it determines from a successful probe. Yet another tool 415, “pptp_probe”, may require an IP address to be input, and may output the hostname and vendor information it determines from that input. For example, if there is a PPTP-based VPN server running on TCP port 1723, “pptp_probe” will output the hostname of the VPN server, as well as the name of the vendor of the server. A tool such as “nmblookup” may also require an IP address and may determine whether there is NetBios name service on UDP port 137. If the tool “nmblookup” determines that there is NetBios name service on UDP port 137, it outputs the NetBios name and workgroup/domain name for that server if it is available.

“Smbclient”, another tool 415 that may be used in performing a scan of user's network, may require an IP address to be input, and may output NetBIOS share names from a service which implements the SMB protocol on TCP port 139, (e.g., Microsoft networking server, or Unix Samba server) including for example, whether the server is a domain controller or a master browser. “Qtip” is a tool designed by Trustwave® Corporation, and may require an IP address to be input, and may output information relating to whether or not it was successfuil in attempting a Windows null account login, as well as any additional system configuration information that it was able to acquire. “Qtip” may further output user names or share names for the probed system, information security policy settings, such as password policies (e.g., minimum password length, interval for password lifetime, requirements for account lockout on repeated failed logins), and general user account information (e.g. time and date of last login, type of user and whether the user has a password). Another tool developed by Trustwave®, “gbg”, may require an IP address and a TCP/UDP port number to be input, and may output a text string which includes service banners describing the specific application running on a TCP or UDP port, or any other IP protocol. For example, TCP port 25 might run an e-mail server based on the Simple Mail Transfer Protocol (SMTP); however, many vulnerabilities are specific to a particular vendor's implementation. The gbg tool provides a generic method for collecting the “banner” text or data that a TCP or UDP service returns when a network connection is established. This information routinely contains text or other data that will indicate which specific program is running on the server (e.g., Microsoft Exchange or Sendmail) as well as the specific version of that software.

An open-source tool, “wget”, may require an IP address and port as input, and may output one or more pages from a web site. By acquiring and parsing the default web page on a web server (e.g., index.html), the title of the default web page for that address, default cookies, and any user authentication requirements for a web site may be determined. This is an example of an open-source tool used with an analytic tool in order to determine quantifiable information. Another open-source tool, “nikto”, may require an IP address and port as input, and may provide SSL/TLS certificate information and a list of suspicious directories, files and URL's from a web server as output. Yet another open-source tool, “nessus”, may require an IP address, a protocol (such as UDP or TCP) and a port number as input, and may provide a vulnerability code as output, along with any evidence which support a tool's conclusion regarding vulnerability. Another tool that may be used, “dorian”, may require application specific information as input, such as the IP address and port number of a web server, as well as application-specific information, such as usernames and passwords, and may output results based on a multi-sequence probe of a web server, or more specifically of a custom web application.

As discussed above, each scanning tool 415 may be typically associated with a specific operating system or platform and may have been developed independently of the scanning apparatus. Therefore, the input submitted to each scanning tool 415 must be in a specific proprietary or idiosyncratic format. Therefore, when the task handler 418 launches a task and essentially orders a scan be performed, the task handler 418 passes the data to be input into the tool 415 to the input wrapper 428 so that the input wrapper 428 can “wrap”, or translate, the command line and/or configuration file 430 required by each tool 415, into the language required by that tool 415, thereby enabling that tool 415 to perform the task required by the task assignment 416. Once the tool 415 receives the properly “wrapped” or formatted command line and/or configuration file 430, it performs its scanning function as described above, or as described in Table 1, or as known in the art, or as described in the co-filed and co-pending application. In an alternative embodiment, each tool 415 may be robust enough that is able to accept any type of formatted command line and/or configuration file 430, regardless of the operating system upon which it is based. Such a robust tool 415 would eliminate the need for the input wrapper 428.

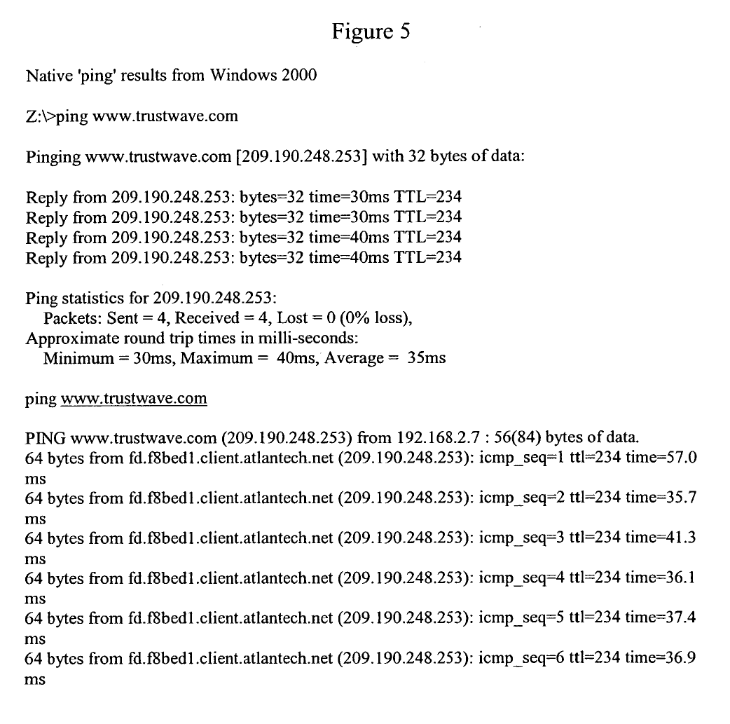

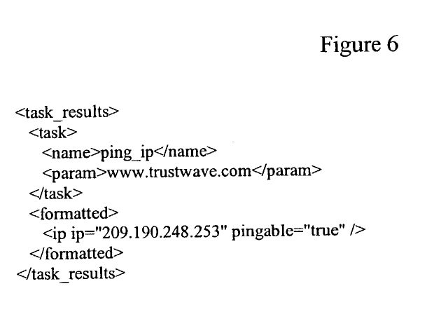

Once the tool 415, tool 370, or first scanning module 230 completes its scanning function, it generates native output 432. FIG. 5 illustrates what the native output 432 of a ping of the website www.trustwave.com looks like. Because the native output 432, generated by the tool 415, might not be in a useful format, the native output 432 may be passed to the output parser 434. In one aspect of the present invention, the output parser 434 “wraps” or translates the native output 432 into a format which is acceptable to the task handler 418. Once native output 432 is wrapped or properly formatted by the output parser 434, it is referred to as task results 436. For example, in transferring the native output 432 into task results 436, the output parser 434 may remove useless information and encode relevant information in a common format which has meaning to the task handler 418. FIG. 6 illustrates what the native output 432 of FIG. 5 looks like after it is passed through the output parser 434 and formatted as task results 436. In an alternative embodiment, the task handler 418 may accept the native output 432 directly from the tool 415, thereby eliminating the need for the output parser 434 to format the data into task results 436.

It should be noted that although only one tool 415 is shown in the scanning module of FIG. 4, the present invention can employ more than one tool 415 at a time. These multiple tools 415 can be used either serially or in parallel. Additionally, the precise order of the steps and the submodules discussed herein and in the co-pending application are merely illustrative, and are not intended to be limiting.

The native output 432 and the task results 436 are also referred to as environment data because the native output 432 and the task results 436 reflect the operating environment of the user's network which is scanned by the scanning tool 415. Upon receiving this environment data the task handler 418 passes it to the environment loader 438, which subsequently stores it on the environment database 440.

In one aspect of the present invention, environment data passed to the environment loader 438 could result in the generation of a new task. Accordingly, new tasks may be generated by analyzing the environment data derived from the task results vis-a-vis the decision tree, which describes how the apparatus should act on new information. For example, the decision tree 444 may instruct the task builder 442 to construct new tasks 413 within the task list 412 in such a manner that the first (initial) task assignment 416 should be performed using the tools “ping” and “mnap”. If the subsequent scans performed by tools 415 “ping” and “nmap” reveal, for example, that the user's network has UDP port 137 and TCP port 139 open, the resulting environment data (within the task results 436 ) is ultimately passed to the environment database 440 via the task handler 418 and environment loader 438. Through the environment loader 438, the task builder 442 determines whether detailed probes should be performed on those open ports and, based on the logic within the decision tree 444. If detailed probes are required, the task builder 442 may, for example, instruct the task manager 414 to send two task assignments 416 to the task handler 418 calling, for example, a tool 415 known as NMBLOOKUP to determine the Windows Domain or Workgroup name from the NetBIOS name service on UDP/137, as well as calling the tool 415 known as SMBCLIENT to probe the user's network to determine more NetBios information from the server running on TCP/139.

Another example of how the environment loader 438, the task manager 414, and the task handler 418 all form a feedback loop can be illustrated by the task handler calling the tool 415 “qtip”, which determines whether null logins are permitted. If the native output 432 or the task results 436, returned to the task handler 418 and then passed to the environment database 440 via the environment loader 438, indicate that the SMB protocol is running on TCP/139, the task builder 422 queues a task to probe this service as per the decision tree 444, which ultimately results in the task handler 418 directing that the tool 415 QTIP attempt to perform a null login, and, if successful, determine any existing file or printer share names and security settings. In another embodiment, if the initial “ping” and “nmap” scans generate environment data which reveals that TCP port 80 is open on the user's network, the task builder 422 queues tasks as described in the logic encoded in the decision tree 444, which ultimately results in the task manager 414 passing a task assignment 416 to the task handler 418 directing that a banner grabbing tool, such as “gbg” or “dotrnatrix”, confirm that the service is actually an implementation of the HTTP protocol and to identify the specific web hosting product, as well as the version of that product which is used (e.g., Microsoft IIS/4.0 or Apache/1.3.12). Once a specific web hosting product and versions are identified, the task builder 422 queues one or more new tasks based on the logic encoded in the decision tree 444, which ultimately results in the task manager 414 passing a task assignment 416 to the task handler 418 directing specific vulnerability tests, in particular known exploits, be performed.

Once all the task assignments 416 in the dynamically generated task list 412 have been performed, resulting in all the generated environment data being stored in the environment database 440, a third phase of network assessment (i.e., the data output or reporting phase). In performing the reporting phase the network parameter input module 220 or other equivalent module described herein can call the reporting module 240. As discussed herein and in the co-pending application, the reporting module 240 generates reports 250, which contain the environment data generated by the scanning of the user's network. Because the environment database 440, as discussed herein and in the co-pending application, can also contain the user data 210 input by the user, or the data generated by the user in response to the on-line questionnaire, the reports 250 can also report on that data as well.

According to the principles of the present invention, the tools 415 called upon by the task handler 418 may perform scans for different reasons. For example, a scan may be conducted to determine whether the user's network contains a specific attribute. Additionally, the tools 415 might scan the user's network to determine whether that network is vulnerable to a certain type of attack from a hacker. Therefore, in another embodiment of the present invention, the task builder 442 can check with the virus and vulnerability database 450 contained in the task module 408 to determine what scans should be performed so as to identify certain viruses and vulnerabilities. In one aspect of the present invention, the vulnerability & virus database 450 may generally comprise a compilation of information about the vulnerabilities and the services they affect (e.g., descriptions, severity levels, remediation information, etc.). In another aspect of the present invention, the scanning apparatus 400 may bypass the virus and vulnerability database 450 and also access public websites or billboards directly to check if new viruses or vulnerabilities have been identified. Such public websites and billboard include SANS/FBI Top 20 www.sans.org, and the Center for Internet Security www.cisecurity.com. Other sources which provide current computer system vulnerabilities may include, for example, www.cert.org, www.securityfocus.org, www.microsoft.com, and www.cve.mitre.org. Further, the scanning apparatus 400 may access such websites and/or billboards, and download the new viruses and vulnerabilities listed there directly into the virus and vulnerability database 450 for future use.

By creating a dynamically generated task list 412, based on processing task results with scan logic as encoded in a Decision Tree, a large amount of detailed information can be determined about a network and it's services. This information can be correlated with information contained within the Vulnerability Database 450, which contains a list of all of the potential vulnerabilities that a tool 415 might reveal. The Vulnerability Database 450 may contain additional logic describing dependencies that must be satisfied if a vulnerability detected by a specific tool 415 is deemed to be valid. For example, one tool 415 (e.g., Nessus) might perform a test which checks for specific vulnerabilities on a web server.

According to the principles of the present invention, the scan apparatus 400 may be scalable to different networks and operating platforms as well as is scalable to different ranges of security. In one aspect of the present invention, the scalability of the scanning apparatus 400 may be adjusted through the task manager 414, and tasks carried out by the task handler 418. For example, the scalability of the scanning function results from separating the function of task module 408 managing the tasks from the function of the scan module 410 actually performing the tasks. In one embodiment this is accomplished by the task manager 414 assigning tasks to multiple scan tools 415 and/or multiple scan modules 410. Additionally, the interface between the task manager 414 and performance, including the scalable separation, may also provide additional flexibility by allowing scanning tools 415 with different operating systems to be used in the same scanning apparatus. Multiple scanning tools 415 may allow larger numbers of commercial, open source, proprietary, and other scanning tools 415 to be used. For example, the decision tree may associate tools with particular operating systems by assigning “qtip” to a Windows based system and “nmap” to a Linux based system. By providing multiple tools 415, a wider variety of both open source and commercial tools to be used within the scanning apparatus of the present invention, as the various “best of breed” tools do not all run on a common operating system. Additionally, the separation of functionality between the task module 408 and the scan module 410 allows network, connection, or other resource intensive tools to be run on specific platforms and/or outside firewalls. For example, “nmap” and similar port scanners are often difficult to utilize when their host system is situated behind a firewall. According to the principles of the present invention, by separating the task module 408 from scan module (or otherwise separating the scan management functionality from the scan implementation functionality), it is possible to place predetermined scanning tools “in front of”, or outside, a firewall while affording firewall protection to more sensitive or proprietary tools by placing their host platforms “behind” a firewall. Further, separation of the scan management functionality from the scan implementation functionality enables scan implementation functionality (e.g., scan module 410, etc.) to be deployed within an enterprise network while the corresponding scan management functionality is deployed within an external network.

The foregoing description the preferred embodiment of the invention has been presented for the purposes of illustration and description. It is not intended to be exhaustive or to limit the invention to the precise form disclosed. Many modification and variations are possoble in light of the above teachings. It is intended that the scope of the invention be limited not by this detailed description but rather by the claims appended hereto.

What is claimed is:

1. An apparatus for use as a network security device, comprising:
a network parameter input module;
a first network scanner module having an input in communication with an output of said network parameter input module; and
a reporting module having an input in communication with an output of said first network scanner module.

2. The apparatus of claim 1, further comprising a second network scanner module having an input in communication with an output of said network parameter input module and having an output in communication with an input of said reporting module.

3. The apparatus of claim 1, wherein said network parameter input module comprises data input by a user.

4. The apparatus of claim 1, wherein said network parameter input module comprises data provided responsive to a questionnaire.

5. The apparatus of claim 1, wherein said network parameter input module comprises an error checking module to assess validity of provided data.

6. The apparatus of claim 1, wherein said network parameter input module comprises a database of network addresses.

7. The apparatus of claim 1, wherein said network parameter input module comprises a database of user names.

8. The apparatus of claim 1, wherein said network parameter input module comprises a parameter settings database.

9. The apparatus of claim 8, wherein said parameter settings database comprises data relating to at least one parameter selected from the group consisting of network addresses, MAC addresses, network blocks, vulnerabilities of interest, tools to be used for vulnerability detection, maximum tolerances, time of day availability for program execution, scan blackout periods, and frequency of operation.

10. The apparatus of claim 1, wherein said first network scanner module comprises a network scanning tool having an input and an output.

11. The apparatus of claim 1, wherein said first network scanner module comprises at least one tool selected from the group a consisting of nslookup, dig, whois, ping, traceroute, rpcinfo, nbtstat, net use, smbclient, nmblookup, nmap, nessus, whisker, nikto, onesixtyone, lantern, pptp_probe, Gbg, Wget, QTIP, DORIAN, Internet Security Systems Scanner, Cybercop Scanner, and Cisco Security Scanner.

12. The apparatus of claim 1, wherein said first network scanner module comprises a module adapted to create a scan list based on data from said network parameter input module.

13. The apparatus of claim 1, wherein said first network scanner module comprises a module adapted to create an inventory of exposed systems on a network.

14. The apparatus of claim 1, wherein said first network scanner module comprises a module adapted to create an inventory of exposed services on a network.

15. The apparatus of claim 1, wherein said first network scanner module comprises a module adapted to analyze results of probing a network.

16. The apparatus of claim 1, wherein said first network scanner module comprises a module adapted to probe a system to make a status determination regarding identifiable vulnerabilities.

17. The apparatus of claim 1, wherein said reporting module comprises a homogenizing module adapted to receive data in one or more formats and present it in a uniform format.

18. The apparatus of claim 1, wherein said reporting module comprises a client environment database.

19. The apparatus of claim 18, wherein said client environment database comprises data corresponding to at least one from the group consisting of scan parameters used in scanning, operating systems, IP registry, vulnerabilities, scan time, last scan date, next scan date, status of network, discovered MAC addresses, scan activity log, exposed systems, exposed services, scanned domain names, scanned IP, discovered IP, and applications used in scanning.

20. The apparatus of claim 1, wherein said network parameter input module is adapted to infer network testing parameters based on a compliance regime input by a user.

21. The apparatus of claim 20, wherein said compliance regime is selected from the group consisting of an industry standard, a corporate regulation, and a governmental regulation.

22. A method for securing a network, comprising:
inputting data to a scanning module;
a first step of scanning a network with a first tool of said scanning module; and
presenting results from said first step of scanning.

23. The method of claim 22, further comprising a second step of scanning a network with a second tool of said scanning module.

24. The method of claim 22, wherein said step of inputting data comprises inputting user data.

25. The method of claim 22, wherein said step of inputting data comprises responding to a questionnaire.

26. The method of claim 22, wherein said step of inputting data comprises checking said data for errors.

27. The method of claim 22, wherein said step of inputting data comprises providing a database of network addresses.

28. The method of claim 22, wherein said step of inputting data comprises providing a database of user names.

29. The method of claim 22, wherein said step of inputting data comprises providing a parameter settings database.

30. The method of claim 29, wherein said parameter settings database comprises data relating to at least one or parameter selected from the group consisting of network addresses, MAC addresses, network blocks, vulnerabilities of interest, tools to be used for vulnerability detection, maximum tolerances, time of day availability for program execution, scan blackout periods, and frequency of operation.

31. The method of claim 22, wherein said first tool comprises a network scanning tool having an input and an output.

32. The method of claim 22, wherein said network scanning tool comprises at least one tool selected from the group consisting of nslookup, dig, whois, ping, traceroute, rpcinfo, nbtstat, net use, smbclient, nmblookup, nmap, nessus, whisker, nikto, onesixtyone, lantern, pptp_probe, Gbg, Wget, QTIP, DORIAN, Internet Security Systems Scanner, Cybercop Scanner, and Cisco Security Scanner.

33. The method of claim 22, wherein said first step of scanning comprises creating a scan list based on data from said network parameter input module.

34. The method of claim 22, wherein said first step of scanning comprises creating an inventory of exposed systems on a network.

35. The method of claim 22, wherein said first step of scanning comprises creating an inventory of exposed services on a network.

36. The method of claim 22, wherein said first step of scanning comprises analyzing results of probing a network.

37. The method of claim 22, wherein said first step of scanning comprises probing a system to make a status determination regarding identifiable vulnerabilities.

38. The method of claim 22, wherein said step of presenting results comprises homogenizing data in one or more formats into a uniform format.

39. The method of claim 22, wherein said step of presenting results comprises generating a client environment database.

40. The method of claim 39, wherein said client environment database comprises data corresponding to at least one from the group consisting of scan parameters used in scanning, operating systems, IP registry, vulnerabilities, scan time, last scan date, next scan date, status of network, discovered MAC addresses, scan activity log, exposed systems, exposed services, scanned domain names, scanned IP, discovered IP, and applications used in scanning.

41. The method of claim 22, wherein said step of inputting data comprises inferring network testing parameters based on a compliance regime input by a user.

42. The method of claim 41, wherein said compliance regime is selected from the group consisting of an industry standard, a corporate regulation, and a governmental regulation.

43. A method of assessing compliance of a computer network, comprising:
generating a first task set comprising a first plurality of instructions;
generating scan tasks for analyzing a computer network;
selecting predetermined ones of the generated scan tasks in accordance with the first plurality of instructions;
generating a second task set comprising the selected scan tasks;
generating at least one task assignment comprising a portion of the second task set;
analyzing the computer network using the at least one task assignment; and
reporting results of analyzing the computer network.

44. The method of claim 43, wherein generating the first task set comprises:
inputting data regarding the computer network; and
generating the first plurality of instructions based on the inputted data.

45. The method of claim 43, wherein the generating the second task set comprises adding at least one additional scan task required to analyze the computer network.

46. The method of claim 45, wherein the at least one additional task comprises an instruction to listen to packets on the computer network.

47. The method of claim 43, wherein generating the second task set comprises prioritizing the selected scan tasks.

48. The method of claim 43, wherein generating the second task set comprises adding at least one task based on the results of analyzing the computer network.

49. The method of claim 43, wherein the analyzing comprises:
selecting at least one scanning tool from a tool library; and
applying the selected scanning tool to the computer network.

50. The method of claim 49, wherein the selecting at least one scanning tool comprises simultaneously selecting a plurality of scanning tools.

51. The method of claim 49, wherein the selecting at least one scanning tool comprises sequentially selecting a plurality of scanning tools.

52. The method of claim 43, wherein the analyzing comprises providing at least one scanning tool, wherein the at least one scanning tool is responsive to instructions within the at least one task assignment.

53. The method of claim 52, wherein the analyzing comprises providing a plurality of scanning tools, at least two of the plurality of scanning tools being operable on different operating systems.

54. The method of claim 52, wherein the analyzing further comprises translating instructions within the at least one task assignment into at least one of a language and a format required by the at least one scanning tool.

55. The method of claim 43, wherein the analyzing comprises determining whether the computer network can be analyzed, wherein the computer network is analyzed if it is determined the computer network can be analyzed.

56. The method of claim 43, wherein the reporting comprises generating native output based on the analyzing of the computer network, the native output comprising results of analyzing the computer network.

57. The method of claim 56, wherein the reporting further comprises translating the generated native output into at least one of a common language and a common format.

58. A system for scanning a computer system, comprising:
a task management module for generating at least one task assignment, the at least one task assignment comprising instructions for scanning at least one computer network; and
at least one scanning module for receiving the at least one task assignment and for scanning the at least one computer network in accordance with the instructions.

59. The system of claim 58, wherein the at least one scanning module comprise a plurality of scanning modules.

60. The system of claim 58, wherein the at least one scanning module comprises at least one tool for scanning the at least one computer network.

61. The system of claim 60, wherein the at least one scanning module comprises a plurality of scanning modules.

62. The system of claim 58, wherein the at least one task assignment comprises instructions based on data inputted by a user.

63. The system of claim 58, wherein the at least one task assignment comprises instructions based on a result of the scanning by the at least one scanning module.
